(19) United States
(12) Patent Application Publication
(10) Pub. No.: US 2004/0040916 A1
(43) Pub. Date: Mar. 4, 2004

(54) Concrete component reclamation process and system

(76) Inventor: Donald J. Ruppert, Hamburg, NY (US)

Correspondence Address: JOSEPH P. GASTEL, 295 MAIN ST., SUITE 722, BUFFALO, NY, 14203, US

(21) Appl. No.: 10/234,453

(22) Filed: Sep. 4, 2002

(51) Int. Cl. C02F 9/00

(52) U.S. Cl. 210/805; 210/806; 210/259; 210/388

(57) ABSTRACT

A process for reclaiming the components of left-over concrete including the steps of adding water to the concrete to produce a first mixture, effecting a first screening of the first mixture to separate any stones and gravel present in the first mixture and produce a second mixture of sand, cement and water, cycloning the second mixture into a first portion containing water and cement and into a second portion containing sand and cement and water, effecting a second screening of the second portion to separate sand from the cement and water, and in a filter press separating the cement from the water from the second portion of the second mixture and separating the cement from the water from the first portion of the second mixture.

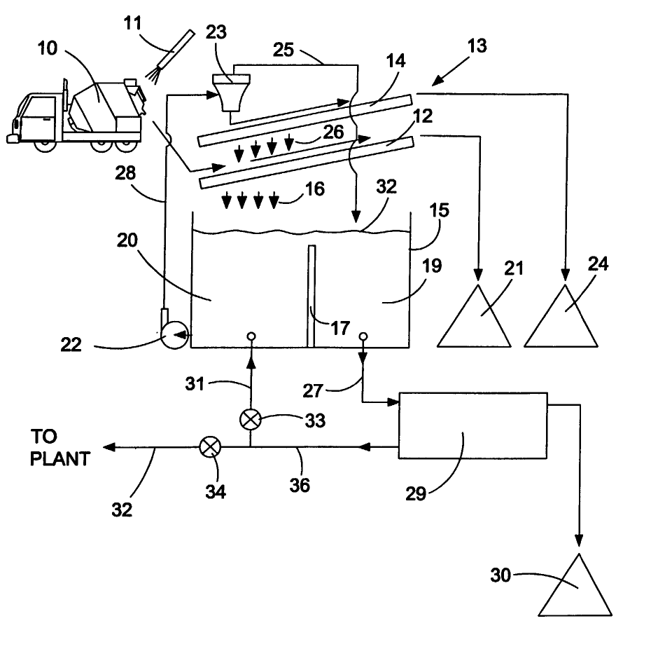

### CROSS-RFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

The present invention relates to an improved concrete component reclamation process wherein the components of the concrete are separated for selective reuse or disposal.

By way of background, there are occasions when a truck with a rotatable drum of concrete returns to a concrete plant with a partial load of concrete which has to be removed from the truck. The concrete consists of cement and water and an aggregate which may consist of sand or gravel or stones or combinations thereof. A concrete plant may make any or all of the foregoing combinations, and usually makes all of them. The procedure is to wash the drum of the truck with water to remove the concrete. It is with the efficient and economical disposal and selective reuse of the various components of the concrete and added water that the present invention is concerned.

### BRIEF SUMMARY OF THE INVENTION

It is the object of the present invention to separate the components of concrete which may consist of cement and water and an aggregate consisting of any of stones and gravel and sand or combinations thereof into various components so that their disposal and selective reuse may be effected in a simple, efficient, organized and economical manner.

It is another object of the present invention to provide an improved method of reclaiming components of concrete, especially water, so that they may be reused, thereby conserving resources and avoiding contamination of the environment.

A further object of the present invention is to provide an improved system for reclaiming components of concrete for selective reuse. Other objects and attendant advantages of the present invention will readily be perceived hereafter.

The present invention relates to a process for reclaiming the components of concrete which contains an aggregate and cement and water comprising the steps of adding water to said concrete to produce a mixture, separating said mixture into a first portion containing said aggregate and into a second portion containing cement and water, and separating said second portion into cement and cleansed water.

The present invention also relates to a process as set forth in the immediately preceding paragraph wherein said aggregate contains one or both of stones and gravel in said mixture, and screening said mixture to separate said one or both of said stones and gravel from said mixture to obtain said first portion containing said one or more of stones and gravel and to obtain said second portion containing said cement and water.

The present invention also relates to a process for reclaiming the components of concrete which contains cement and water and an aggregate of sand and one or both of stones and gravel comprising the steps of adding water to said concrete to produce a mixture, screening said mixture into a first portion containing said any or both of said stones and gravel and into a second portion containing sand and cement and water, separating said second portion into a third portion containing sand and water and into a fourth portion containing cement and water, and separating said fourth portion into cement and cleansed water.

The present invention also relates to conducting water which is separated from each of the above processes back to the concrete plant and if desired, back to a portion of each of the above processes prior to the step of separating water and cement from the above-discussed mixture of cement and water.

The present invention also relates to a system for reclaiming the components of concrete which contains an aggregate and cement and water comprising a vibratory screen for separating concrete into said aggregate and into a mixture of sand and water, and separating said mixture into sand and cleansed water.

The various aspects of the present invention will be more readily understood when the following portions of the specification are read in conjunction with the accompanying drawing wherein:

### BRIEF DESCRIPTION OF THE DRAWING

The figure is a schematic view of the structure for practicing the improved method of the present invention.

### DETAILED DESCRIPTION OF THE INVENTION

There are occasions when a truck comes back to the concrete plant with a partial load of concrete which has not been used. The procedure is to wash the rotatable drum with water to remove the concrete and cleanse the drum. In accordance with the present invention, the present process treats this watered concrete to separate the various components which may exist therein into separate components, namely, into the aggregate, cement and cleansed water, and the cleansed water may be recirculated to the concrete plant for reuse or returned to the process for separating the components or both. Thus, the separate components may be disposed of or further processed or reused in an orderly and efficient manner.

The improved method of the present invention will be initially described relative to processing a concrete mixture which contains cement and water and the aggregate of stone, gravel and sand. It will thereafter be described relative to a concrete mixture which contains cement and water and an aggregate which contains an aggregate which is less than all three of stones, gravel and sand.

In accordance with the present method, after a truck 10 returns to the concrete plant with a partial load of concrete containing cement, water, stones, gravel and sand, a spray 11 of water is used to clean the drum of the truck to produce a first mixture. This first mixture of stone, gravel, sand, cement and water from the truck is deposited onto the lower screen 12 of a two-layered vibratory screening machine 13 which also has an upper screen 14 overlying the lower screen. Machines of this type are known in the art. A machine of this type is also manufactured by Derrick Manufacturing Corporation of Buffalo, N.Y., as Derrick Model CRS-423. The screens 12 and 14 are located above chambered tank 15 which has two chambers 19 and 20 with a weir 17 therebetween. During the initial screening of the first mixture on the lower screen, a second mixture consisting of the sand, cement and water is deposited into chamber 20 from the lower screen 12, as indicated by arrows 16. The sand and gravel is dumped off of the screen 12 into a pile 21. The stone and gravel may be reused or disposed of in any suitable manner.

A centrifugal feed pump 22 is in communication with chamber 20, and it feeds the second mixture of sand, cement and water through conduit 28 to a cyclone separator 23 which is located at the lower end of the upper screen 14. While a centrifugal feed pump 22 is preferred, it will be appreciated that any suitable pump may be used. Cyclone separators are well known in the art, and any suitable cyclone separator may be used. A four-inch cyclone separator manufactured by Derrick Manufacturing Corporation has been used. The sand is separated from the second mixture by the cyclone separator 23 and is deposited on the lower end of the upper screen 14. The sand, on average, may have about 20% moisture therein. Any water and traces of cement which pass with the sand onto upper screen 14 pass through the upper screen 14 and through the lower screen 12 back to chamber 20 of tank 15, as indicated by arrows 26. The sand is conveyed off of the end of upper screen 14 into a pile 24. The sand may be reused or disposed of in any suitable manner.

The mixture of water and cement from cyclone separator 23 is passed through a suitable conduit 25 to chamber 19. The mixture in chamber 19 is known as gray water, and it is passed through conduit 27 to a filter press 29 which separates water and cement from the gray water into cement and cleansed waste water. The cement is formed into a cake-form which is discharged from the filter press. The filter press is a well known type of machine, and the specific model which has been used is identifiable as Derrick EP-800, and is a product of the Derrick Manufacturing Corporation. While a filter press is preferred, it will be appreciated that the separation may be effected by other devices such as a centrifuge or clarifier-belt press combination, both of which are well known in the art. The cement which has been recovered may be reused or it may be otherwise suitably disposed of.

Part of the separated cleansed water from filter press 29 can be conducted back to chamber 20 of tank 15 through conduits 36 and 31 to be reused in the above described cycle, and part of the separated cleansed waste water can be conveyed through conduit 32 for use in the concrete manufacturing process, for example, to be added to the concrete which is to be removed from a truck. Suitable valves 33 and 34 are associated with conduits 31 and 32, respectively, to regulate the amount of separated cleansed water which is routed through these conduits. By reusing the cleansed water, it is thus not only conserved but also does not contaminate the environment.

The amount of water in the system will depend on the amount which is added by spray 11. Accordingly, the following conditions can exist. The level in chambers 19 and 20 may be below the top of weir 17 or the level in both chambers may be above the top of weir 17, as shown at 32, or the level 32 in chamber 19 may be even with top of the weir 17 and the level in chamber 20 may be below the top of weir 17. Most of the time the water level 32 is above the top of weir 17, as shown at 32, because a larger amount of gray water enters chamber 19 than can be used by the filter press. Any excess gray water which passes over weir 17 into chamber 20 is recirculated by pump 22 to cyclone separator 23.

While it is preferred to use a two-layered vibratory screening machine 13 such as described above, it will be appreciated that the process can also be performed with separate vibratory screening machines which may be placed side-by-side or otherwise oriented so that the screened water and sand is deposited into the tank chamber 20 or in suitable tanks from which the screened water and sand is routed to the cyclone separator.

The above description has treated a concrete mixture containing cement and water and an aggregate of stones, gravel and sand. It will be appreciated that a concrete mixture containing cement and water and an aggregate of only stones or gravel would be treated in the same manner, but that only gravel or stones would be separated on screen 12 and the remainder of the mixture would be treated in the same manner as described above for the concrete mixture of stones, gravel, sand, cement and water except that there would be no sand deposited on screen 14.

If the concrete mixture contained cement and water and an aggregate of only stones or gravel and sand, it would be treated in the same manner as described above for a concrete mixture containing gravel, sand, cement and water.

If the concrete mixture contained cement and water and an aggregate of only sand, it would be treated in the same manner as described above for any of the foregoing mixtures. The concrete mixture would be deposited on screen 12, and the sand, cement and water would immediately pass therethrough into chamber 20 of tank 15. There would be no stones or gravel carried by screen 12. The remainder of the process would be the same as described above relative to the concrete mixture containing stones, gravel, sand, cement and water.

If the concrete mixture contained only cement and water, the same procedure would be followed as set forth above relative to the mixture which contained stones, gravel, sand, cement and water. In this respect, the mixture of cement and water would be deposited onto screen 12 and would immediately fall therethrough into chamber 20 of tank 15. The cement and water would then be pumped by pump 22 to cyclone separator 23 and the gray water liquid from the cyclone separator would pass through conduit 25 into chamber 19 of tank 15. There would be no sand deposited from cyclone 23 onto screen 14. The cement-water mixture would then be processed from chamber 19 as described above.

As noted above, it is possible to perform the method of the present invention with separate vibratory screening machines wherein the screens 12 and 14 are placed side-by-side and they can overlie a single tank, such as 15, or separate tanks wherein two chambers, such as chamber 20, are connected by a suitable conduit. In such orientation there need be only a single chamber, such as 19, associated with one of the chambers 20 inasmuch as chamber 19 receives gray water only from cyclone 23, and it does not pass through screens 12 and 14, whereas chamber 20 receives material from both screens 12 and 14.

By virtue of the foregoing process, any of the desired components and clean waste water can be separated from a concrete mix which contains cement and water plus none of or any of or all of an aggregate of stones, gravel and sand which is supplied from the concrete truck and, if desired, all the components may be available for reuse. Additionally, if they are not to be reused, they are separated into discreet quantities which may be conveniently disposed of.

While a preferred method of the present invention has been disclosed, it will be appreciated that it is not limited thereto but may be otherwise embodied within the scope of the following claims.

1. A process for reclaiming the components of concrete which contains an aggregate and cement and water comprising the steps of adding water to said concrete to produce a mixture, separating said mixture into a first portion containing said aggregate and into a second portion containing cement and water, and separating said second portion into cement and cleansed water.

2. A process for reclaiming the components of concrete as set forth in claim 1 wherein said first portion containing said aggregate also contains water and may contain traces of cement, and screening said first portion into a third portion containing water and any traces of cement and into a fourth portion containing said aggregate.

3. A process for reclaiming the components of concrete as set forth in claim 2 including the step of adding said third portion containing water and any traces of cement to said second portion containing cement and water.

4. A process for reclaiming the components of concrete as set forth in claim 2 including the step of separating said third portion into cleansed water and cement.

5. A process for reclaiming the components of concrete as set forth in claim 1 wherein said first portion containing said aggregate also contains water, and screening said first portion to separate water from said aggregate.

6. A process for reclaiming the components of concrete as set forth in claim 5 wherein said aggregate comprises sand.

7. A process for reclaiming the components of concrete as set forth in claim 1 wherein said mixture is separated in a cyclone separator into said first portion containing said aggregate and into said second portion containing cement and water.

8. A process for reclaiming the components of concrete as set forth in claim 7 wherein said first portion containing said aggregate also contains water and may contain traces of cement, screening said first portion into a third portion containing water and any traces of cement and into a fourth portion containing said aggregate.

9. A process for reclaiming the components of concrete as set forth in claim 7 including the step of separating said third portion into cleansed water and cement.

10. A process for reclaiming the components of concrete as set forth in claim 1 including the step of providing said cleansed water which has been separated from said second portion to a concrete plant.

11. A process for reclaiming the components of concrete as set forth in claim 10 including the step of also returning a portion of said cleansed water which has been separated from said second portion to said second portion.

12. A process for reclaiming the components of concrete as set forth in claim 1 wherein said aggregate contains one or both of stones and gravel in said mixture, and screening said mixture to separate said one or both of said stones and gravel from said mixture to obtain said first portion containing said one or more of stones and gravel and to obtain said second portion containing said cement and water.

13. A process for reclaiming the components of concrete as set forth in claim 12 including the step of separating said third portion into cleansed water and cement.

14. A process for reclaiming the components of concrete as set forth in claim 13 including the step of providing said cleansed water which has been separated from said second portion to a concrete plant.

15. A process for reclaiming the components of concrete which contains cement and water and an aggregate of sand and one or both of stones and gravel comprising the steps of adding water to said concrete to produce a mixture, screening said mixture into a first portion containing said any or both of said stones and gravel and into a second portion containing sand and cement and water, separating said second portion into a third portion containing sand and water and into a fourth portion containing cement and water, and separating said fourth portion into cement and cleansed water.

16. A process for reclaiming the components of concrete as set forth in claim 15 including the step of providing cleansed water from said fourth portion to a concrete plant.

17. A process for reclaiming the components of concrete as set forth in claim 16 including the step of conducting said separated cleansed water from said fourth portion back to said fourth portion.

18. A process for reclaiming the components of concrete as set forth in claim 16 including the step of conducting cleansed water from said fourth portion to said second portion.

19. A process for reclaiming the components of concrete as set forth in claim 15 including the step of screening said second portion containing sand and cement and water into a fifth portion containing sand and into a sixth portion containing cement and water, and separating said sixth portion into cement and cleansed water.

20. A process for reclaiming the components of concrete as set forth in claim 19 wherein said cement and cleansed water from said sixth portion is separated along with the separation of cement and cleansed water from said fourth portion.

21. A process for reclaiming the components of concrete as set forth in claim 20 including the step of providing separated cleansed water from said fourth and sixth portions to a concrete plant.

22. A process for reclaiming the components of concrete as set forth in claim 20 including the step of conducting separated cleansed water from said fourth and sixth portions back to said second portion.

23. A process for reclaiming the components of concrete as set forth in claim 22 including the step of providing separated cleansed water from said fourth and sixth portions to a concrete plant.

24. A system for reclaiming all the components of concrete which contains a mixture of an aggregate and cement and water comprising a first vibratory screen for separating a first part of said aggregate from said mixture, a first chamber below said vibratory screen for receiving a second mixture comprising a second part of said aggregate and cement and water, a cyclone separator in communication with said first chamber for separating said second mixture into a first portion containing said second part of said aggregate and water and into a second portion containing cement and water, a second vibratory screen below said cyclone separator for separating said first portion into said second aggregate and into cement and water, a second chamber for receiving said second portion from said cyclone separator, and a cleansed water and cement separator in communication with said second chamber.

25. A system for reclaiming the components of concrete as set forth in claim 24 comprising a cleansed water conduit in communication with said water and cement separator.

26. A system for reclaiming the components of concrete as set forth in claim 25 wherein said cleansed water conduit is in communication with said first chamber.

27. A system for reclaiming the components of concrete as set forth in claim 25 wherein said cleansed water conduit provides cleansed water to a concrete plant.

28. A system for reclaiming the components of concrete which contains an aggregate and cement and water comprising a vibratory screen for separating concrete into said aggregate and into a mixture of cement and water, and separating said mixture into cement and cleansed water.
